(19) United States
(12) Patent Application Publication
(10) Pub. No.: US 2016/0339576 A1
(43) Pub. Date: Nov. 24, 2016

(54) HANDHELD DEVICE FOR DRIVING A STATOR BLADE INTO A BLADE GROOVE

(71) Applicant: SIEMENS AKTIENGESELLSCHAFT, München (DE)

(72) Inventor: Stefan Bentele, Mülheim an der Ruhr (DE)

(73) Assignee: Siemens Aktiengesellschaft, Munich (DE)

(21) Appl. No.: 15/109,666

(22) PCT Filed: Dec. 22, 2014
(86) PCT No.: PCT/EP2014/078989

§ 371 Date: Jul. 5, 2016

(30) Foreign Application Priority Data
Jan. 15, 2014 (EP) 14151233.5

(51) Int. Cl. B25D 9/26; F01D 21/00

(52) U.S. Cl. CPC B25D 9/26; F01D 21/003; B25D 2250/005; B25D 2250/101; B25D 2250/181; B25D 2250/221; F05D 2230/60; F05D 2220/30; F05D 2240/12; F05D 2260/83

(57) ABSTRACT

A handheld device for driving a stator blade into a blade groove arranged on a stator blade support of a turbine and which contains at least one stem element, having a striking device for carrying out individual hammer strikes of specifiable forces onto the stator blade to be driven, a trigger device for manually triggering an individual hammer strike to be carried out using the striking device, a detecting device for detecting respective installation force of the stator blade to be driven, the installation force being achieved with an individual hammer strike carried out using the striking device, an electronic analyzing device for analyzing each installation force of the stator blade to be driven, the installation force being detected using the detecting device, and at least one signaling device for signaling the installation force of the stator blade to be driven, the installation force being detected using the detecting device.

### CROSS REFERENCE TO RELATED APPLICATIONS

This application is the U.S. National Stage of International Application No. PCT/EP2014/078989 filed Dec. 22, 2014, and claims the benefit thereof. The International Application claims the benefit of European Application No. EP14151233 filed Jan. 15, 2014. All of the applications are incorporated by reference herein in their entirety.

### FIELD OF INVENTION

The invention relates to a handheld device for driving a stator blade into a blade groove arranged on a stator blade support of a turbine and containing at least one caulking element.

### BACKGROUND OF INVENTION

A turbine, in particular a steam or gas turbine, usually has a stator blade device, arranged in a housing of the turbine, by means of which a driving fluid can be guided at an optimum angle to rotor blades of the turbine. Such a stator blade device comprises a stator blade support and multiple stator blades fastened to the stator blade support.

A stator blade is usually fastened by hand to a stator blade support. A stator blade root is hereby inserted into a blade root present on a stator blade support until the stator blade has assumed its intended position relative to the stator blade support. An intended position of the stator blade relative to the stator blade support is usually secured by means of a caulking element which is deformed for this purpose. Coupling of the stator blades fastened to a stator blade support can then take place via a covering strip.

A caulking element can be driven into a blade groove after a stator blade root has been arranged as intended in the blade groove. It has, however, been shown that a stator blade device can be produced in a more time-saving and hence cost-effective fashion if a caulking element is first arranged in a blade groove on a stator blade support and a stator blade root is then driven into the blade groove. The latter manner of producing a stator blade device is advantageous within the scope of the invention.

For corresponding fastening of a stator blade to a stator blade support, the stator blade is usually driven in less ergonomically with hammer blows via a caulking element. This method entails a high degree of manual effort and rapid tiring of staff occupied with fastening the stator blades such that it is generally necessary to factor in fifteen minutes of recovery time for the staff per working hour. In the case of production of stator blade devices, staff usually need to fasten up to 100,000 stator blades per year correspondingly to stator blade supports, which conventionally entails a significant amount of work and time.

In addition, whilst fastening a stator blade to a stator blade support the staff have to decide whether a stator blade root of a stator blade slides too easily or too tightly into a blade groove formed on a stator blade support. The former requires swapping the caulking element present in the blade groove for a thicker caulking element, and the latter swapping the caulking element present in the blade groove for a thinner caulking element. The stator blade group formed from the stator blades arranged on the stator blade support could come loose during operation of a stator blade device as a result of stator blades that have been inserted too loosely into a stator blade support, which could cause blades to be torn off. In the case of too tightly inserted stator blades, a stator blade root of a stator blade could damage a blade groove formed on the stator blade support, and a bearing surface on the stator blade support.

### SUMMARY OF INVENTION

The object of the invention is to provide a new option for fastening stator blades on a stator blade support by means of which such a fastening can take place more ergonomically and with a lower amount of force being exerted.

The handheld device according to the invention for driving a stator blade into a blade groove, arranged on a stator blade support of a turbine and containing at least one caulking element, comprises—a striking device for performing individual hammer blows of a predetermined strength on the stator blade to be driven in,—a trigger device for manually triggering an individual hammer blow to be performed with the striking device,—a recording device for recording the inserting force, for the stator blade to be driven in, obtained in each case with an individual hammer blow performed with the striking device,—an electronic evaluation device for evaluating the inserting force, for the stator blade to be driven in, recorded in each case with the recording device, and—at least one signaling device for signaling the inserting force, for the stator blade to be driven in, recorded with the recording device.

By means of the handheld device according to the invention, there is no need to perform any hammer blows by hand when driving a stator blade into a blade groove, provided with a caulking element, on a stator blade support, so that this driving in of the stator blade can take place with significantly less force being exerted and more ergonomically. By recording the inserting force, for the stator blade to be driven in, obtained in each case with an individual hammer blow performed with the striking device, by means of the recording device and by correspondingly signaling this inserting force by means of the signaling device, feedback is received from driving in the stator blade on the basis of which the staff can judge whether the driven-in stator blade slides too loosely, optimally, or too tightly into the blade groove formed on a stator blade support in order to be able to avoid the abovementioned disadvantages connected with too loose or too tight an insertion of a stator blade.

The striking device for performing individual hammer blows of a predetermined strength on the stator blade to be driven in can be designed in any suitable manner. The striking device advantageously comprises a drive means and a striking body which can be driven via the drive means, for example in the form of a firing pin, in order to be able to perform the individual hammer blows.

The trigger device for manually triggering an individual hammer blow to be performed with the striking device can be mechanical or electromechanical in design. It is essential for the invention that only individual hammer blows can be triggered by the trigger device and that staff occupied with driving a stator blade into a blade groove on a stator blade support receive feedback after each individual hammer blow on the inserting force for the stator blade which is obtained each time.

The recording device for recording the inserting force, for the stator blade to be driven in, obtained in each case with an individual hammer blow performed with the striking device can have any suitable sensor means for recording the inserting force.

The electronic evaluation device for evaluating the inserting force, for the stator blade to be driven in, recorded in each case with the recording device is connected to the recording device by communications technology in order to be able to receive and evaluate the inserting force recorded. For this purpose, the electronic evaluation device can have a microprocessor and a memory unit.

The at least one signaling device for signaling the inserting force, for the stator blade to be driven in, recorded with the recording device is connected to the electronic evaluation device by communications technology in order to receive signals from the electronic evaluation device and to be able to output signals corresponding to the respective inserting force for the stator blade.

The turbine can be designed, for example, as a steam turbine or as a gas turbine.

The signaling device is advantageously configured to visually signal the inserting force. For this purpose, the signaling device can have a visual display which is configured to represent alphanumerically, by color, and/or symbolically a signal corresponding to the respective inserting force for the stator blade.

The signaling device is advantageously configured to acoustically signal the inserting force. For this purpose, the signaling device can have a speaker which emits an acoustic signal corresponding to the respective inserting force for the stator blade to be driven in.

The handheld device advantageously has an adjustment device for manually adjusting the strength of an individual hammer blow to be performed with the striking device. This makes it possible to individually and optimally adapt the handheld device to the respective circumstances and requirements.

The handheld device advantageously has a display device for displaying the strength, set manually via the setting device, of an individual hammer blow to be performed with the striking device. As a result, staff handling a handheld device receive feedback on the strength which has been set in each case of an individual hammer blow to be performed with the striking device.

The handheld device advantageously has a handle for manually handling the handheld device. This makes it possible to safely and simply handle the handheld device. The handle can be designed taking ergonomic aspects into account.

The handle is advantageously designed as a pistol grip. This makes it possible to particularly simply and intuitively handle the handheld device.

The trigger device is advantageously arranged in the region of the handle. As a result, the handheld device can be operated with just one hand. The trigger device can be designed and arranged in the form of a trigger like those on firearms.

The striking device advantageously has at least one driving body which is formed at least partially from copper. Copper is a significantly softer material than the material from which stator blades to be driven in are produced. As a result, damage to the stator blade when a stator blade is driven in is prevented. In addition, an end of the driving body which comes into contact with the stator blade when the latter is driven in is plastically deformed in such a way that a contact surface on the driving body which is optimal for driving in the stator blade is formed. The driving body can also be formed from a different material which is designed to be suitably soft.

The striking device advantageously has a pneumatic drive means. The handheld device can be connected to a supply of compressed air, via which the pneumatic drive means is supplied with compressed air. Alternatively, the handheld device can have its own compressed air tank. The striking device can alternatively have an electromechanical drive means.

The signaling device advantageously has at least one sensor unit for recording a deflection, generated by an individual hammer blow performed with the striking device, of a striking body of the striking device.

The sensor signals of the sensor unit can be sent to the electronic evaluation device which carries out a comparison of the recorded deflection of the striking body with predetermined threshold values, for example according to the invention, from which it can be concluded whether the respective inserting force of a stator blade after an individual hammer blow performed with the striking device is too small, too great, or optimal.

### BRIEF DESCRIPTION OF THE DRAWINGS

Embodiments of the handheld device according to the invention are explained below with the aid of the attached schematic drawings, in which:

FIG. 1 shows a schematic perspective view of an exemplary embodiment for a handheld device according to the invention,

FIG. 2 shows a schematic view of an exemplary application of a handheld device according to the invention.

### DETAILED DESCRIPTION OF INVENTION

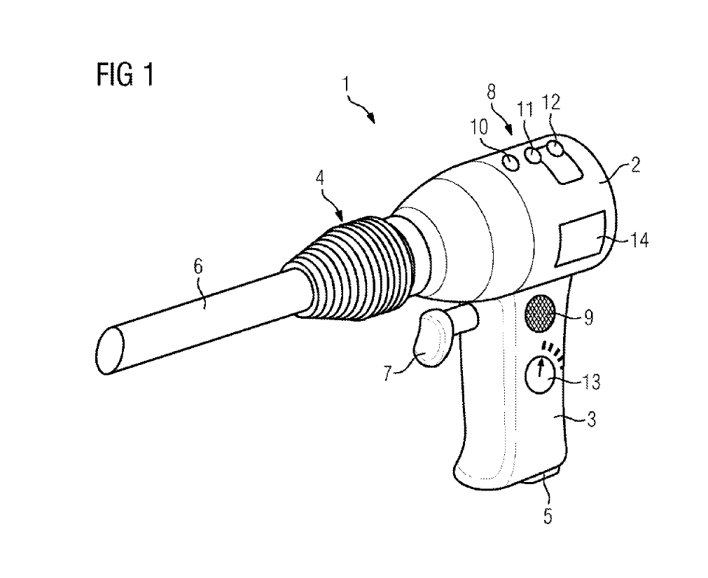

FIG. 1 shows a schematic perspective view of an exemplary embodiment for a handheld device 1 according to the invention for driving a stator blade (not shown) into a blade groove, arranged on a stator blade support (not shown) of a turbine and containing at least one caulking element (not shown). The handheld device 1 has a housing 2 on which a handle 3 in the form of a pistol grip for manually handling the handheld device 1 is formed.

The handheld device 1 furthermore comprises a striking device 4 (not shown in detail) for performing individual hammer blows of a predetermined strength on the stator blades to be driven in. The striking device 4 has a pneumatic drive, arranged in the housing 2, which can be supplied with compressed air via a compressed air connection 5. The striking device 4 additionally has a copper driving body 6. The striking device 4 moreover comprises a striking body (not shown) which can be activated by means of the pneumatic drive to perform individual hammer blows.

The handheld device 1 furthermore comprises a trigger device 7 for manually triggering an individual hammer blow to be performed with the striking device 4, wherein the trigger device 4 is arranged in the region of the handle 3 and is similar to a trigger like those on firearms.

The handheld device 1 furthermore comprises a recording device, not shown in detail and arranged in the housing 2, for recording the inserting force, achieved each time with an individual hammer blow performed with the striking device 4, of the stator blade to be driven in. The recording device has at least one sensor unit for recording a deflection, generated by an individual hammer blow performed with the striking device 4, of the striking body of the striking device 4.

The handheld device 1 furthermore comprises an electronic evaluation device (not shown), arranged in the housing 2, for evaluating the inserting force, recorded in each case with the recording device, of the stator blade to be driven in.

The handheld device 1 furthermore comprises a signaling device for signaling the inserting force, recorded with the recording device, of the stator blade to be driven in. The signaling device is configured to visually signal the inserting force by means of a visual display 8, arranged on the housing 2, of the signaling device. The signaling device is furthermore configured to acoustically signal the inserting force by means of an acoustic signal unit 9 of the signaling device. The visual display 8 has three display panels 10, 11 and 12, wherein the respective inserting force of the stator blade to be driven in can be signaled by a different number of activated and consequently illuminated display panels 10, 11 and 12 or by activation of one of the display panels 10, 11 or 12 corresponding to the respective inserting force. In the latter case, the display panels 10, 11 and 12 can be illuminated with different colors. The acoustic signal unit 9 has a speaker which can emit a noise or a tone corresponding to the respective inserting force.

The handheld device 1 furthermore has a setting device 13 for manually setting the strength of an individual hammer blow to be performed with the striking device 4. In addition, the handheld device 1 has a display device 14 for displaying the strength, set manually in each case via the setting device 13, of an individual hammer blow to be performed with the striking device 4. The display device 14 can have an alphanumeric digital display.

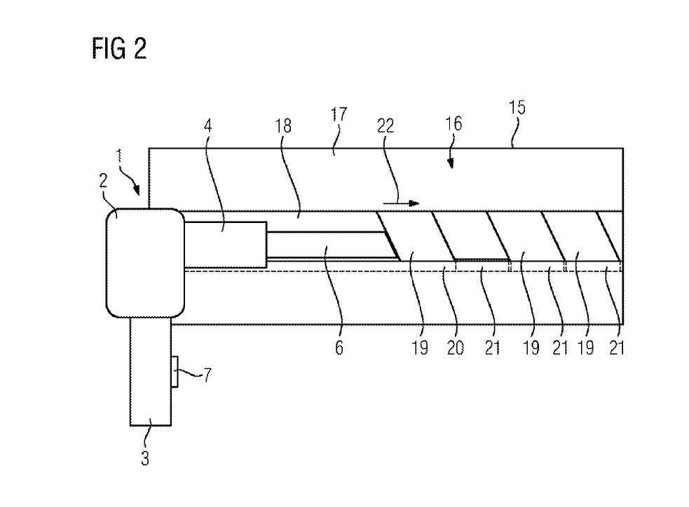

FIG. 2 shows a schematic view of an exemplary application of a handheld device 1 according to the invention, wherein the handheld device 1 is shown highly schematically and can be designed in accordance with the exemplary embodiment shown in FIG. 1.

A portion 15 of a stator blade device 16 situated in an assembled state can be seen, wherein the stator blade device 16 has a stator blade support 17 on which a blade groove 18 is formed. Multiple stator blades 19 are already fastened on the stator blade support 17. For this purpose, a caulking slot 20, into which a separate caulking element 21 is inserted for each stator blade 19, is formed on the blade groove 18. It is intended for the stator blade 19 shown on the left in FIG. 2 to be driven with the handheld device 1 in the direction of the arrow 22 into its proper position relative to the stator blade support 17 via the caulking element 21 associated with it. For this purpose, the copper driving body 6 is brought into contact (as shown) with the left-hand stator blade 19 and an individual hammer blow to be performed with the striking device 4 is then triggered by means of the trigger device 7. As a result, the left-hand stator blade 19 moves by a certain amount in the direction of the arrow 22, wherein this amount is recorded via the recording device, evaluated by the electronic evaluation device, and signaled to a person operating the handheld device 1 by means of the signaling device.

Although the invention was illustrated and described in detail by the exemplary embodiments, the invention is not limited by the examples disclosed and other variants can be derived therefrom by a person skilled in the art without going beyond the protective scope of the invention.

1. A handheld device for driving a stator blade into a blade groove, arranged on a stator blade support of a turbine and containing at least one caulking element, comprising:
a striking device for performing individual hammer blows of a predetermined strength on the stator blade to be driven in,
a trigger device for manually triggering an individual hammer blow to be performed with the striking device,
a recording device for recording the inserting force, for the stator blade to be driven in, obtained in each case with an individual hammer blow performed with the striking device,
an electronic evaluation device for evaluating the inserting force, for the stator blade to be driven in, recorded in each case with the recording device, and
at least one signaling device for signaling the inserting force, for the stator blade to be driven in, recorded with the recording device.

2. The handheld device as claimed in claim 1,
wherein the signaling device is configured to visually signal the inserting force.

3. The handheld device as claimed in claim 1,
wherein the signaling device is configured to acoustically signal the inserting force.

4. The handheld device as claimed in claim 1, further comprising:
a setting device for manually setting the strength of an individual hammer blow to be performed with the striking device.

5. The handheld device as claimed in claim 4, further comprising:
a display device for displaying the strength, manually set via the setting device, of an individual hammer blow to be performed with the striking device.

6. The handheld device as claimed in claim 1, further comprising:
a handle for manually handling the handheld device.

7. The handheld device as claimed in claim 6,
wherein the handle is designed as a pistol grip.

8. The handheld device as claimed in claim 6,
wherein the trigger device is arranged in the region of the handle.

9. The handheld device as claimed in claim 1,
wherein the striking device has at least one driving body which is formed at least partially from copper.

10. The handheld device as claimed in claim 1,
wherein the striking device has a pneumatic drive.

11. The handheld device as claimed in claim 1,
wherein the recording device has at least one sensor unit for recording a deflection, generated by an individual hammer blow performed with the striking device, of a striking body of the striking device.
